(19) United States
(12) Patent Application Publication
(10) Pub. No.: US 2025/0004154 A1
(43) Pub. Date: Jan. 2, 2025

(54) EVENT PICKING IN SEISMIC DATA

(71) Applicant: Schlumberger Technology Corporation, Sugar Land, TX (US)

(72) Inventors: Tao Zhao, Houston, TX (US); Phillip Bilsby, Gatwick (GB); Sunil Manikani, Pune (IN); Aria Abubakar, Houston, TX (US)

(21) Appl. No.: 18/704,558

(22) PCT Filed: Jan. 12, 2023
(86) PCT No.: PCT/US2023/060544

§ 371 Date: Apr. 25, 2024

Related U.S. Application Data
(60) Provisional application No. 63/299,248, filed on Jan. 13, 2022.

(51) Int. Cl. G01V 1/28; G01V 1/30

(52) U.S. Cl. CPC G01V 1/282; G01V 1/288; G01V 1/303; G01V 2210/41; G01V 2210/6222

(57) ABSTRACT

A method includes receiving seismic data representing a subterranean volume, including a plurality of signals, obtaining a machine learning model trained to predict energy arrivals in the signals using seismic data that does not represent the subterranean volume, predicting energy arrivals in a quality control portion of the plurality of signals of the seismic data using the machine learning model, determining that the predicted energy arrivals for the quality control portion are not accurate, training the machine learning model to predict the energy arrivals using a training data set that represents the subterranean volume, predicting the energy arrivals in the seismic data using the machine learning model that was trained based at least in part on the training data set, and generating a velocity model based on the predicted energy arrivals.

### CROSS-REFERENCE TO RELATED APPLICATIONS

This application claims priority to U.S. Provisional Patent Application having Ser. No. 63/299,248, which was filed on Jan. 13, 2022 and is incorporated herein by reference in its entirety.

### BACKGROUND

Seismic first break event picking is a process for detecting or picking the onset of arrivals of seismic signals in individual records generated by receiver arrays. In a given survey, there may be billions of seismic records, and the individual seismic records may include thousands of data points. When picking first break events, the location of first break is identified within the individual seismic records within a survey. Picking the first break events in a survey in an accurate and consistent manner permits building a near surface velocity model, which has a direct impact of the seismic image and the decision making in hydrocarbon exploration.

The current practice for seismic first break event picking involves many iterative steps that are time consuming. This is further complicated by moderate to low quality data, which impairs the accuracy of the present picking processes.

### SUMMARY

Embodiments of the disclosure include a method including receiving seismic data representing a subterranean volume, the seismic data including a plurality of signals, and obtaining a machine learning model trained to predict energy arrivals in the signals. The machine learning model was trained using seismic data that does not represent the subterranean volume. The method includes predicting energy arrivals in a quality control portion of the plurality of signals of the seismic data using the machine learning model, determining that the predicted energy arrivals for the quality control portion are not accurate, and in response to determining that the predicted energy arrivals are not accurate, training the machine learning model to predict the energy arrivals using a training data set that represents the subterranean volume. The method also includes predicting the energy arrivals in the seismic data using the machine learning model that was trained based at least in part on the training data set, and generating a velocity model based on the predicted energy arrivals.

Embodiments of the disclosure include a computing system including one or more processors and a memory system including one or more non-transitory computer-readable media storing instructions that, when executed by at least one of the one or more processors, cause the computing system to perform operations. The operations include receiving seismic data representing a subterranean volume, the seismic data including a plurality of signals, obtaining a machine learning model that is globally-trained to predict energy arrivals in the signals, predicting energy arrivals in a quality control portion of the plurality of signals of the seismic data using the machine learning model, determining that the predicted energy arrivals for the quality control portion are not accurate, in response to determining that the predicted energy arrivals are not accurate, training the machine learning model to predict the energy arrivals using a local training data set that represents the subterranean volume, predicting the energy arrivals in the seismic data using the machine learning model that was trained based at least in part on the training data set, and generating a velocity model based on the predicted energy arrivals.

Embodiments of the disclosure include a computer-readable medium storing instructions that, when executed by at least one processor of a computing system, cause the computing system to perform operations. The operations include receiving seismic data representing a subterranean volume, the seismic data including a plurality of signals, obtaining a machine learning model that is globally-trained to predict energy arrivals in the signals, predicting energy arrivals in a quality control portion of the plurality of signals of the seismic data using the machine learning model, determining that the predicted energy arrivals for the quality control portion are not accurate, in response to determining that the predicted energy arrivals are not accurate, training the machine learning model to predict the energy arrivals using a local training data set that represents the subterranean volume, predicting the energy arrivals in the seismic data using the machine learning model that was trained based at least in part on the training data set, and generating a velocity model based on the predicted energy arrivals.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a flowchart of a method for generating a velocity model of a subterranean volume, according to an embodiment.

FIGS. 5A and 5B illustrate a schematic view of a workflow for predicting a first break in a seismic survey, according to an embodiment.

FIG. 6 illustrates a flowchart of a method for predicting a first break in a seismic survey, according to an embodiment.

FIG. 7 illustrates a schematic view of a computing system, according to an embodiment.

### DESCRIPTION OF EMBODIMENTS

In general, convolutional neural networks (CNN) may provide the backbone for a deep learning method for identifying energy arrivals in seismic data sets. For purposes of illustration, embodiments of the present disclosure may be described specifically for predicting first breaks, but it will be appreciated that various embodiments may be employed to predict other breaks. The CNN-based seismic first break picking may be considered an image segmentation problem. The inputs to a CNN model are fixed-size images extracted from seismic gathers (e.g., common shot gathers or CSGs). Although this disclosure refers to common shot gathers, the workflow may be employed for other data sorting orders, including common receiver gathers, common offset gathers, and common midpoint gathers. Further, the seismic data may not be moveout-corrected prior to feeding into the CNN model. The outputs are 2D probability maps of first break picks that have the same size as the input images. A sample of the highest probability above a threshold along each seismic trace is assigned as the location of the first break, so that we have at most one pick per seismic trace.

The CNN model may be provided with human prepared training examples including pairs of seismic data and corresponding first break picks. The training examples may be diverse, covering different near surface conditions, survey geometry, and noise types. This trained CNN model may serve as a global baseline, which can be used to either directly infer first breaks on a new dataset or continue training on a small set of examples (e.g., fewer than 100 seismic common shot gathers) prepared from the target dataset before inference. Such continued training paradigm is often referred to as transfer-learning. “Human-in-the-loop” retraining can also be employed, meaning refining a small set of prediction results and adding back to the training set.

The architecture of the CNN model may be flexible, and may include several tens of convolutional layers, as well as pooling and batch-normalization layers. The CNN model loss function contains multiple loss and regularization terms, including binary cross-entropy, which is commonly used for image segmentation, as well as L2-norm on model weights, L2-norm on vertical and horizontal differences, and L2-norm on total sample intensity. Comparing to other CNN-based seismic first break picking studies, the regularization terms on vertical (v) and horizontal (h) differences and total sample intensity (e) are unique in this application, which are defined as:

$$v = {\sum }_{i , j = 2}^{i = M , j = N} ‖ {p}_{i , j} - {p}_{i , j - 1} ‖ ,$$

$$h = {\sum }_{i , j = 2}^{i = M , j = N} ‖ {p}_{i , j} - {p}_{i - 1 , j} ‖ ,$$

$$and$$

$$e = {\sum }_{i , j = 1}^{i = M , j = N} {p}_{i , {j}^{2}} ,$$

where p_{i,j} is a pixel in the 2D first break probability map of size M by N.

In traditional workflows, first break picking is conducted iteratively to quality control and refine the result. Further, expert picks in most locations may be expected to be consistent, but discrepancies may be apparent in challenging locations (e.g., low data quality). Therefore, taking the picks that are consistent among multiple experts and rejecting others can provide an indication of which are the high confidence picks. Following a similar strategy, an ensemble of multiple CNN models with different network architectures may be provided and trained independently to serve as multiple experts. The first break picks that are consistent among the multiple CNN models may then be selected, while, e.g., excluding others, to enhance confidence of prediction.

The consistency is defined as follows: for a given seismic trace, if the spread among picks from the various CNN models is less or equal to a threshold, the mean of these picks is assigned as the final pick; otherwise, the picks are rejected on the trace and the trace is marked as no valid pick. In this way, uncertainty involved in the picks is reduced and may reduce the amount of quality control needed. For a typical seismic survey, the proposed workflow can reduce the total turnaround time from weeks to one or two days.

Reference will now be made in detail to embodiments, examples of which are illustrated in the accompanying drawings and figures. In the following detailed description, numerous specific details are set forth in order to provide a thorough understanding of the disclosure. However, it will be apparent to one of ordinary skill in the art that the disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the disclosure. The first object and the second object are both objects, respectively, but they are not to be considered the same object.

The terminology used in the description of the disclosure herein is for the purpose of describing particular embodiments only and is not intended to be limiting of the disclosure. As used in the description of the disclosure and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

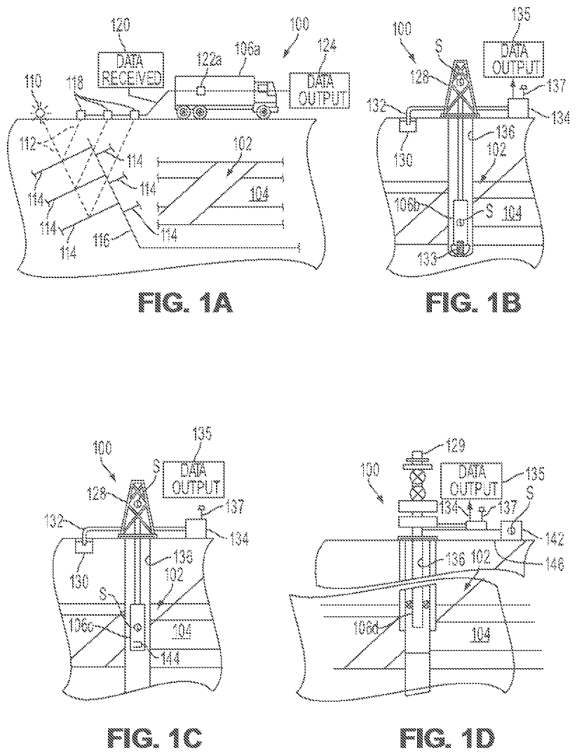

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

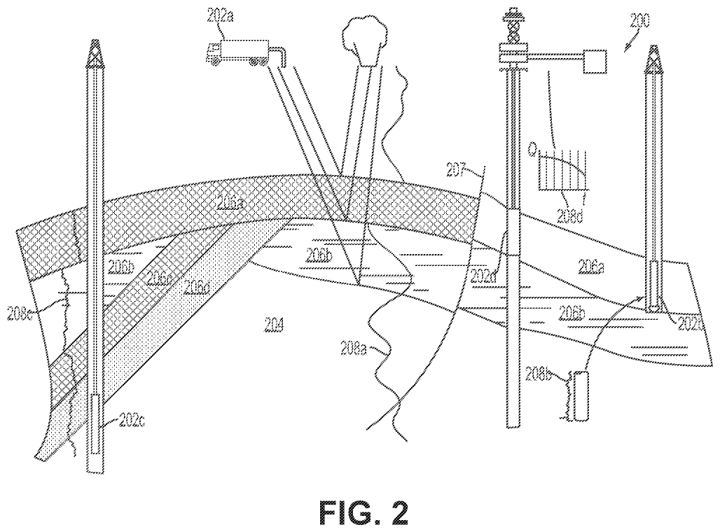

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

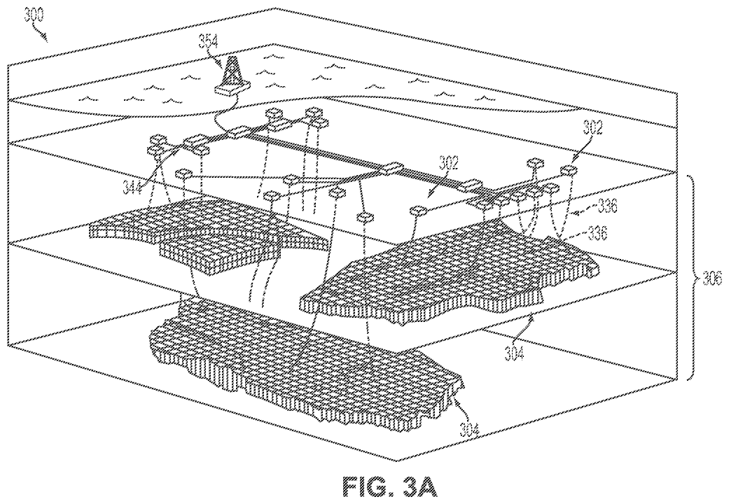

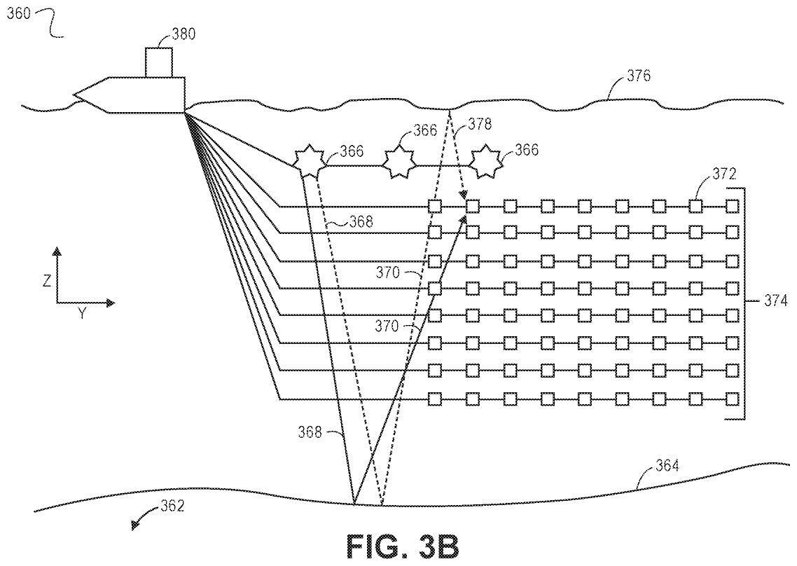

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

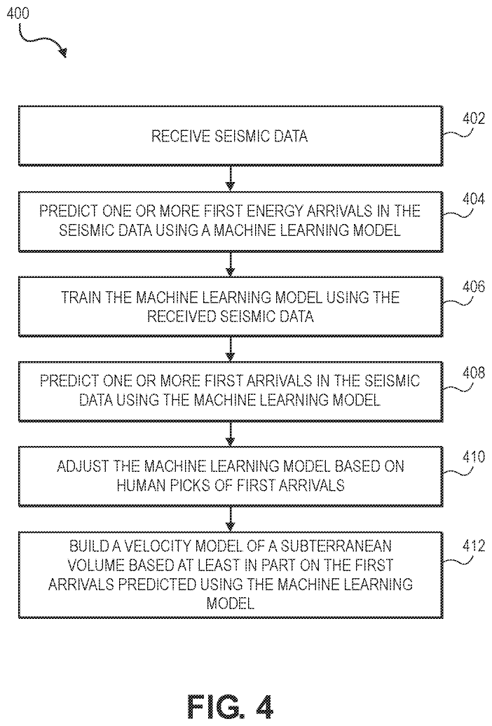

FIG. 4 illustrates a flowchart of a method 400 for generating a velocity model of a subterranean volume of interest, according to an embodiment. It will be appreciated that the worksteps of the method 400 may be executed in the order presented herein, or in any other order. Further, individual worksteps may be partitioned into two or more separate worksteps. Additionally, some of the worksteps may be combined into a single workstep and/or performed in parallel.

The method 400 includes receiving seismic data, as at 402. The seismic data may be collected using a receiver array positioned along a surface of the volume of interest. In other embodiments, the seismic data may be collected by one or more receivers positioned within a well, e.g., as a vertical seismic profile (VSP) process.

The method 400 may also include predicting one or more energy arrivals (e.g., first breaks) in the seismic data using a machine learning model, as at 404. As discussed in greater detail below, the machine learning model may initially be trained “globally”, that is, trained to predict first arrivals or other features in a seismic signal based on seismic signals that were potentially not collected from the subsurface volume of interest (e.g., those that do not “represent” the subterranean seismic volume of interest), but rather in seismic surveys from other locations/volumes that may or may not share certain (e.g., geological) physical similarities with the subterranean volume of interest.

In some cases, the globally trained model may accurately select the first arrivals, but in other cases, such a globally-trained machine learning model may not make accurate predictions with high levels of confidence. Accordingly, the method 400 may include training the machine learning model using a portion of the seismic data that was received at 402, as at 406. This may be a “global-to-local” training, in which the machine learning model may be trained for the particularities of this specific seismic volume, this specific recording array, or both. Thus, signal quality characteristics may be taken into consideration. Human experts may pick the first arrivals to establish ground-truths for the local training.

The method 400 may then include predicting one or more first arrivals in the seismic data using the machine learning model, as at 408. The results of this prediction may be employed and/or quality checked. The quality check process, represented by block 410 may include comparing the machine learning predictions with human expert identifications, and then adjusting the machine learning model as appropriate to minimize the difference therebetween.

The picked first arrivals may then be employed to build a velocity model of the subterranean volume, as at 412, which may be used to generate digital models (and display/visualize images) of the subsurface volume. Such digital models have a wide variety of practical applications in the art, such as, for example, in exploration to predict reservoir locations, in well planning to establish trajectories and drilling parameters, and/or in treatment to establish treatment (e.g., fracturing) plans.

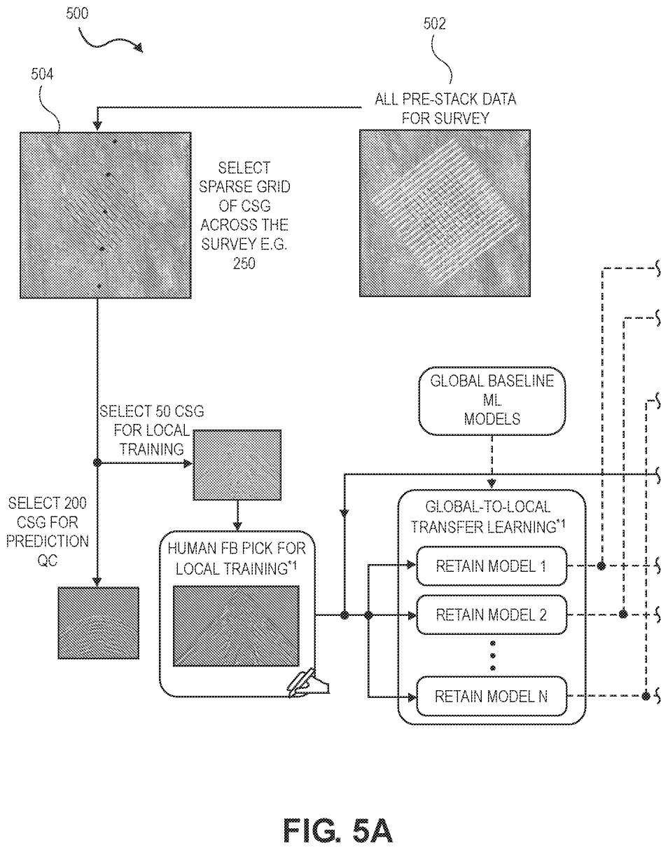

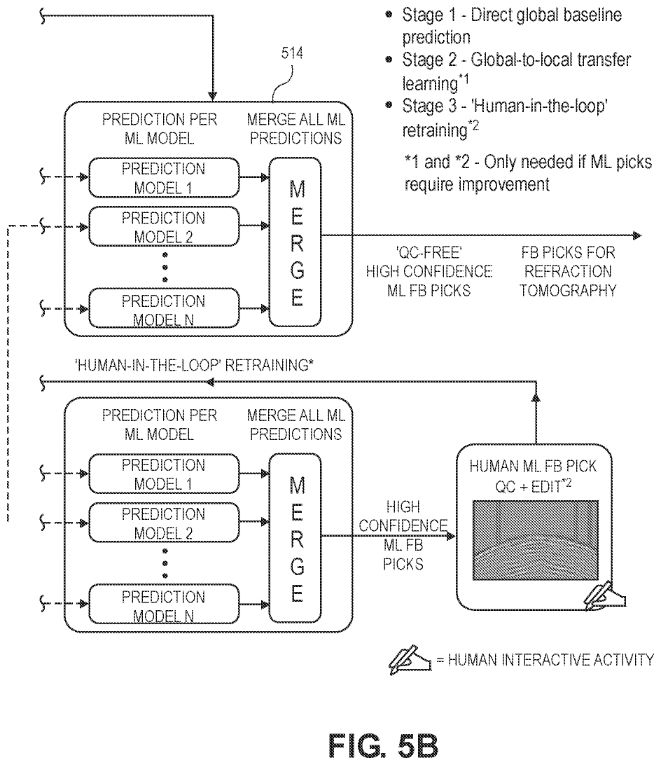

FIGS. 5A and 5B illustrate a schematic of a workflow 500 for predicting first breaks in a seismic signal, according to an embodiment. The workflow 500 may, in some embodiments, implement an example of the method 400. The workflow 500 may begin by receiving pre-stack data 502 from a survey. The workflow 500 may then proceed to a training and quality control phase, which generally starts by moving to the left from the block 502. As shown, a sparse grid of common shot gathers (CSGs) may be selected, at block 504. For example, 250 CSGs may be selected. This may represent, for example, a combination of the QC and training portions of the data.

The QC subset of the CSGs, e.g., 200 of the 250 images, may be fed to a machine learning model, as indicated at 506. At this point in the workflow 500, the machine learning model may have been trained using “global” data (e.g., data collected from surveys that did not produce the received seismic data) and not local data (e.g., the received seismic data representing the specific subterranean volume of interest). Further, in at least some embodiments, the machine learning model may be several different machine learning models, e.g., trained using different types of data and/or generated using different architectures. The predictions of these different models may be merged into a prediction with a confidence value. For example, a first subset of the first breaks (or other arrivals) that are selected across several different machine learning models may be considered high confidence selections, based on the consistency of the predictions thereof by the multiple machine learning models. By contrast, a second subset of the predictions, which are selected by one or relatively few models, and not by others, may be low confidence selections. The first subset of high-confidence predictions, and not the second subset of low-confidence predictions, may then be used as the overall predictions by the machine learning model in the workflow 500. The low-confidence predictions may be ignored in at least some embodiments.

The machine learning model may be used to predict the first breaks in the seismic signals that are fed to it. These predictions, e.g., the high confidence predictions, may then be compared to selections of the first break as picked by a human expert, as indicated at box 508. If the machine learning model's predictions match the human expert's selections, the model may be considered to be making accurate predictions. In some embodiments, in this quality-control phase, human picks may not be available. In at least some embodiments, the human expert may review the predictions made by the globally-trained model for accuracy, which is within the scope of determining whether the model's predictions “match” the human picks.

On the other hand, if the globally-trained model's predictions do not match the human user's predictions to a certain, e.g., threshold, degree, the workflow 500 may proceed with training the machine learning model using the local data. Thus, the remaining 50 (as a specific example) CSGs that were not used for QC purposes (e.g., the “training portion” or “training data set” of the CSG images) may be analyzed by a human user, who may manually identify the first breaks, at 510. The pairings of the training portions of the selected CSG images and the human-created labels may be employed as ground truths to train the machine learning model at 512. The locally-trained machine learning model may then be run to predict the first breaks of the QC portion of the CSG images, which may then be compared to the human selections at 508. The human selections at 508 may be compared to the model predictions at 506 and employed to retrain the model, e.g., to minimize a cost function describing the difference therebetween.

Once trained and quality checked, whether by global-training, local-training, or human-led refinement, or a combination thereof, the workflow 500 may then use the machine learning model to predict the first breaks of the remaining pre-stack data, as at 514.

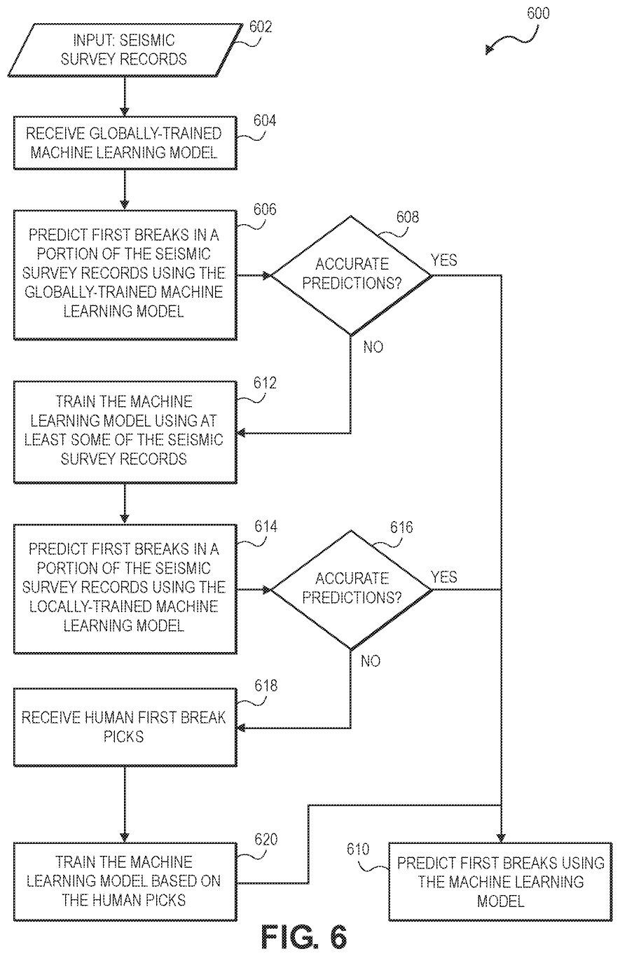

FIG. 6 illustrates a flowchart of a method 600 for selecting first breaks in a seismic survey, according to an embodiment. The method 600 may include receiving, as input, seismic survey records (e.g., pre-stack, common shot gathers), as at 602. The method 600 may also include receiving a globally-trained machine learning model, as at 604. As noted above, the machine learning model may include several different machine learning models, e.g., having different architectures, trained on different data, etc. As part of implementing the machine learning model, the predictions of the different machine learning models may be “merged” or otherwise combined to form a single prediction with a confidence level. Further, the globally-trained machine learning model may be trained using data and ground truths from a wide variety of sources that may not be specific to the area, characteristics, etc. of the input seismic survey records received at 602.

The method 600 may then include predicting first breaks in a quality-control portion of the seismic survey records, as at 606. These predictions may be compared to human-implemented or otherwise generated labels for the quality-control portion of the seismic survey records to determine the accuracy of the predictions, as at 608. If the predicted location of the first breaks matches the human-identified location of the first breaks above a threshold (e.g., a certain percentage that is predetermined or implemented based on a statistical measure), the method 600 may determine that the predictions are accurate (i.e., ‘YES’ at 608). In such case, the method 600 may proceed to predicting first breaks in at least some of the remaining seismic survey records using the machine learning model, as at 610.

Otherwise, the method 600 may proceed to training the machine learning model using at least some of the seismic survey records, as at 612. For example, the machine learning model may be trained using a “training” portion of the seismic survey records. The training portion of the seismic survey records may be labeled, e.g., by a human, with the location of the first breaks, which may serve as ground truths for training the machine learning model.

Once the machine learning model is locally-trained at 612, predictions may be made by the machine learning model, e.g., for the QC portion of the seismic data, as at 614. Those predictions may be again evaluated. The method 600 may thus again determining whether the predictions are accurate, as at 616, by comparison to human-identified locations. Again, if the predictions are accurate, the method 600 may employ the machine learning model to predict the locations of the first breaks in the remainder of the seismic survey data at 610.

Otherwise, the method 600 may proceed to training the machine learning model based on human labels, e.g., using the QC portion of the seismic survey records, or any other portion. For example, the method 600 may include receiving human first break picks, as at 618, and training the machine learning model based on the human picks, as at 620. In some embodiments, the human-feedback stage may occur intermittently, or in response to a trigger, e.g., if confidence levels in the picks by the machine learning model drop below a certain threshold. The method 600 may then proceed to predicting the first breaks using the machine learning model, as at 610.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

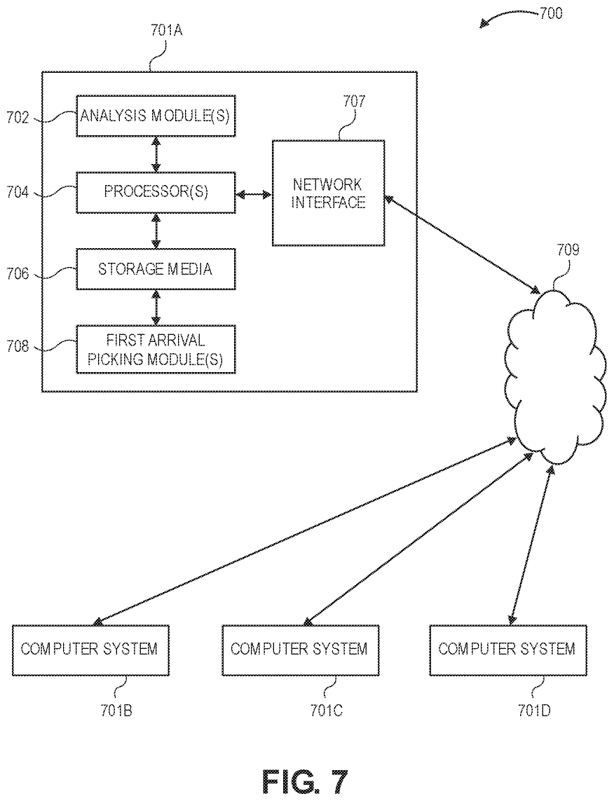

In some embodiments, any of the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis module(s) 702 configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor can include a microprocessor, microcontroller, processor module or subsystem, programmable integrated circuit, programmable gate array, or another control or computing device.

The storage media 706 can be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 700 contains one or more first arrival picking module(s). In the example of computing system 700, computer system 701A includes the first arrival picking module 708. In some embodiments, a single first arrival picking module may be used to perform some or all aspects of one or more embodiments of the methods. In alternate embodiments, a plurality of first arrival picking modules may be used to perform some or all aspects of methods.

It should be appreciated that computing system 700 is only one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the disclosure.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the disclosure and its practical applications, to thereby enable others skilled in the art to best utilize the disclosure and various embodiments with various modifications as are suited to the particular use contemplated.

What is claimed is:

1. A method, comprising:
receiving seismic data representing a subterranean volume, the seismic data including a plurality of signals;
obtaining a machine learning model trained to predict energy arrivals in the signals, the machine learning model was trained using seismic data that does not represent the subterranean volume;
predicting energy arrivals in a quality control portion of the plurality of signals of the seismic data using the machine learning model;
determining that the predicted energy arrivals for the quality control portion are not accurate;
in response to determining that the predicted energy arrivals are not accurate, training the machine learning model to predict the energy arrivals using a training data set that represents the subterranean volume;
predicting the energy arrivals in the seismic data using the machine learning model that was trained based at least in part on the training data set; and
generating a velocity model based on the predicted energy arrivals.

2. The method of claim 1, wherein determining that the predicted energy arrivals for the quality control portion are not accurate includes:
receiving human-generated labels of predicted energy arrivals for the quality control portion; and
comparing the human-generated labels with the predicted energy arrivals for the quality control portion.

3. The method of claim 1, wherein the machine learning model includes a plurality of machine learning models, predicting the energy arrivals in the quality control portion includes predicting the energy arrivals in the quality control portion includes:
receiving predictions from the plurality of machine learning models;
determining that a first subset of the predictions are low-confidence predictions based on inconsistency in the predictions by the different machine learning models; and
determining that a second subset of the predictions are high-confidence predictions based on consistency between the predictions received from the plurality of machine learning models,
the predicted energy arrivals include the high-confidence predictions and not the low-confidence predictions.

4. The method of claim 1, wherein the training data set includes a portion of the seismic data that was received.

5. The method of claim 1, wherein the training data set includes ground-truths that are human-applied.

6. The method of claim 1, wherein training the machine learning model in response to determining that the predicted energy arrivals are not accurate includes:
again predicting the energy arrivals in the quality control portion of the plurality of signals using the machine learning model after training the machine learning model using the training data set;
determining that the again predicted energy arrivals are not accurate;
in response to determining that the again predicted energy arrivals are not accurate:
receiving human-applied labels for the quality control portion of the seismic data; and
training the machine learning model based at least in part on the quality control portion and the human-applied labels for the quality control portion.

7. The method of claim 1, wherein the energy arrivals include first breaks representing reflected seismic signals.

8. The method of claim 1, comprising generating a digital display including an image representing the subterranean volume based at least in part on the velocity model.

9. A computing system comprising one or more processors and a memory system including one or more non-transitory computer-readable media storing instructions that, when executed by at least one of the one or more processors, cause the computing system to perform operations, the operations comprising:
receiving seismic data representing a subterranean volume, the seismic data including a plurality of signals;
obtaining a machine learning model that is globally-trained to predict energy arrivals in the signals;
predicting energy arrivals in a quality control portion of the plurality of signals of the seismic data using the machine learning model;
determining that the predicted energy arrivals for the quality control portion are not accurate;
in response to determining that the predicted energy arrivals are not accurate, training the machine learning model to predict the energy arrivals using a local training data set that represents the subterranean volume;
predicting the energy arrivals in the seismic data using the machine learning model that was trained based at least in part on the training data set; and
generating a velocity model based on the predicted energy arrivals.

10. The computing system of claim 9, wherein determining that the predicted energy arrivals for the quality control portion are not accurate includes:
receiving human-generated labels of predicted energy arrivals in the quality control portion; and
comparing the human-generated labels with the predicted energy arrivals.

11. The computing system of claim 9, wherein the machine learning model includes a plurality of machine learning models, predicting the energy arrivals in the quality control portion includes predicting the energy arrivals in the quality control portion includes:
receiving predictions from the plurality of machine learning models;
determining that a first subset of the predictions are low-confidence predictions based on inconsistency in the predictions by the different machine learning models; and
determining that a second subset of the predictions are high-confidence predictions based on consistency between the predictions received from the plurality of machine learning models,
the high-confidence predictions and not the low-confidence predictions are used as the predicted energy arrivals for the quality control portion.

12. The computing system of claim 9, wherein the training data set includes a portion of the seismic data that was received.

13. The computing system of claim 9, wherein the training data set includes human-applied ground-truths labels.

14. The computing system of claim 9, wherein training the machine learning model in response to determining that the predicted energy arrivals are not accurate includes:
again predicting the energy arrivals in the quality control portion of the plurality of signals using the machine learning model after training the machine learning model using the training data set;
determining that the again predicted energy arrivals are not accurate;
in response to determining that the again predicted energy arrivals are not accurate:
receiving human-applied labels for the quality control portion of the seismic data; and
training the machine learning model based at least in part on the quality control portion and the human-applied labels for the quality control portion.

15. The computing system of claim 9, wherein the energy arrivals include first breaks representing reflected seismic signals.

16. A computer-readable medium storing instructions that, when executed by at least one processor of a computing system, cause the computing system to perform operations, the operations comprising:
receiving seismic data representing a subterranean volume, the seismic data including a plurality of signals;
obtaining a machine learning model that is globally-trained to predict energy arrivals in the signals;
predicting energy arrivals in a quality control portion of the plurality of signals of the seismic data using the machine learning model;
determining that the predicted energy arrivals for the quality control portion are not accurate;
in response to determining that the predicted energy arrivals are not accurate, training the machine learning model to predict the energy arrivals using a local training data set that represents the subterranean volume;
predicting the energy arrivals in the seismic data using the machine learning model that was trained based at least in part on the training data set; and
generating a velocity model based on the predicted energy arrivals.

17. The medium of claim 16, wherein determining that the predicted energy arrivals for the quality control portion are not accurate includes:
receiving human-generated labels of predicted energy arrivals in the quality control portion; and
comparing the human-generated labels with the predicted energy arrivals.

18. The medium of claim 16, wherein the machine learning model includes a plurality of machine learning models, predicting the energy arrivals in the quality control portion includes predicting the energy arrivals in the quality control portion includes:
receiving predictions from the plurality of machine learning models;
determining that a first subset of the predictions are low-confidence predictions based on inconsistency in the predictions by the different machine learning models; and
determining that a second subset of the predictions are high-confidence predictions based on consistency between the predictions received from the plurality of machine learning models,
the high-confidence predictions and not the low-confidence predictions are used as the predicted energy arrivals for the quality control portion.

19. The medium of claim 16, wherein training the machine learning model in response to determining that the predicted energy arrivals are not accurate includes:
again predicting the energy arrivals in the quality control portion of the plurality of signals using the machine learning model after training the machine learning model using the training data set;
determining that the again predicted energy arrivals are not accurate;
in response to determining that the again predicted energy arrivals are not accurate:
receiving human-applied labels for the quality control portion of the seismic data; and
training the machine learning model based at least in part on the quality control portion and the human-applied labels for the quality control portion.

20. The medium of claim 16, wherein the energy arrivals include first breaks representing reflected seismic signals.
